(19) United States
(12) Patent Application Publication
(10) Pub. No.: US 2023/0338825 A1
(43) Pub. Date: Oct. 26, 2023

(54) MULTI-BALL-TRACK ROULETTE

(71) Applicant: Interblock d.d., Menges (SI)

(72) Inventors: Urban BERGANT, Kamnik (SI); John Joseph CONNELLY, Las Vegas, NV (US); Andrej TOMELJAK, Preserje pri Radomljah (SI); Ajda REMSKAR, Trzic (SI)

(21) Appl. No.: 17/728,545

(22) Filed: Apr. 25, 2022

(51) Int. Cl. A63F 5/00

(52) U.S. Cl. CPC A63F 5/0088; A63F 5/007

(57) ABSTRACT

A multi-ball roulette mechanism having an annular stationary rim with an upwardly curved face around which two or more roulette balls travel. A rotating roulette wheel is positioned in a central opening of the stationary rim, both of which are supported by a base. The two or more roulette balls travel from the curved face into pockets of the roulette wheel. A roulette ball launching system launches the two or more roulette balls spinning around the stationary rim in a direction opposite the roulette wheel. The curved face of the stationary rim includes a path around which the roulette balls travel. The path may include two or more separate tracks or a continual spiral. A first roulette ball is launched by the roulette ball launching system onto the path to rotate around the stationary rim while moving down the curved face toward the roulette wheel as the first roulette ball loses momentum. The second roulette ball is not launched by the roulette ball launching system onto the path until the first roulette ball has moved a sufficient distance down the curved face of the stationary rim.

### TECHNICAL FIELD

The present disclosure relates to gaming apparatus and more particularly to roulette gaming apparatus or systems.

### BACKGROUND

Roulette is a popular wagering game played in casinos and other gaming establishments. In mechanical versions of the game (versus video generated), a roulette ball is launched into a stationary rim having a single angled annular track encircling a spinning roulette wheel. The spinning wheel rotates in the opposite direction of the rotating roulette ball. The roulette ball rotates around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number and color. The particular number represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number and color on the layout corresponding to the ball slot in which the roulette ball came to rest. Winning and losing bets for that game cycle that had been electronically or physically placed on the betting area prior to a bet close time of that game cycle are then determined according to the result. Once the losing bets are collected and the winning bets are paid, a new game cycle starts.

As it can take an extended period of time from the beginning to the end of each game cycle, various attempts have been made to increase the number of balls that might be used during a single game cycle so that more bets can be placed during each game cycle. U.S. Patent Application Publication Number US 2008/0076507 discloses a multiple ball roulette-style that includes two different balls, but the system is virtual and does not disclose a mechanical system that must account for the physics subjected to the balls and the randomness that can occur in a physical system.

U.S. Pat. No. 8,899,586 discloses a roulette system that has a singular annular track within the roulette wheel and a ball launching system that can launch two or more balls consecutively or substantially simultaneously into the singular annular tracks. U.S. Patent Application Publication Number US 2006/0249899 discloses a roulette-like system that involves multiple rubber balls that are dropped onto two roulette-like wheels positioned below a pyramid-shaped section that causes the balls to bounce around before dropping on the wheels.

U.S. Pat. Nos. 6,209,869, 6,497,409 and 6,869,259 disclose roulette systems that have a rotatable disk positioned within a stationary bowl that extends upwardly and outwardly from a position surrounding the disk. The bowl has a steeply sloped interior face with a plurality of vertically spaced concentric annular grooves forming independent tracks. Each track is designed to receive and retain a ball as the ball is propelled in a circular motion around the track but permit each ball to fall downwardly out of the track upon loss of a predetermined amount of momentum. A croupier (or dealer) would manually put each of the balls into motion, one after another, starting from a lower most track to an upper most track in the hopes that each ball in an upper track would not fall out of its track until each of the balls in the lower tracks had done so in an attempt to prevent one ball from interfering with another ball. The slope of the bowl is steep enough that a ball exiting an upper track would not enter any of the lower tracks and instead would drop directly onto the rotatable disk positioned below. If the croupier spun a lower ball faster than an upper ball, then an upper ball might leave its track before the lower ball and interfere with the lower ball.

Pockaj d.o.o. d/b/a Alfastreet Gaming showed a roulette machine at a trade show that had 10 balls (each subsequently launched at an interval of 0.5 s) that travelled on the same track of a stationary rim at the same time and were purposely allowed to collide with each other.

### SUMMARY

A multi-ball roulette mechanism having an annular stationary rim with an upwardly curved face around which two or more roulette balls travel. A rotating roulette wheel is positioned in a central opening of the stationary rim, both of which are supported by a base. The two or more roulette balls travel from the curved face into pockets of the roulette wheel. A roulette ball launching system launches the two or more roulette balls spinning around the stationary rim in either a direction opposite the roulette wheel, the same as the roulette wheel, or both directions. The curved face of the stationary rim includes a path around which the roulette balls travel. The path may include two or more separate tracks or a continual spiral. A first roulette ball is launched by the roulette ball launching system onto the path to rotate around the stationary rim while moving down the curved face toward the roulette wheel as the first roulette ball loses momentum. The second roulette ball is not launched by the roulette ball launching system onto the path until the first roulette ball has moved a sufficient distance down the curved face of the stationary rim.

### BRIEF DESCRIPTION OF THE DRAWINGS

FIG. 1A is an illustration of the key forces acting on a roulette ball within a track.

FIG. 1B is an illustration of a deconstruction of the key forces illustrated in FIG. 1A.

FIG. 2 is a perspective view of a portion of the upper area of a roulette mechanism in accordance with an embodiment.

FIG. 3 is a perspective view of a portion of the roulette mechanism of FIG. 2 illustrating more details of the stationary rim and multiple angled annular tracks encircling the spinning roulette wheel.

FIG. 4A is an illustration of the position of two roulette balls within different tracks of the stationary rim.

FIG. 4B. is an illustration of the key forces acting on the two roulette balls of FIG. 4A and the wheel inclination corresponding to each ball.

FIG. 5 is a perspective view of a portion of the roulette mechanism of FIG. 2 illustrating two balls in different tracks.

FIG. 6 is a perspective view of a portion of the roulette mechanism of FIG. 2 illustrating two balls in different portions of the tracks as the upper ball leaves its track and moves toward a lower track and the lower ball moves toward the roulette wheel.

FIG. 7 is a perspective view of a portion of the roulette mechanism of FIG. 2 illustrating a first ball on the spinning roulette wheel and the upper ball now in the lower track.

FIG. 8 is an illustration of an embodiment of a stationary rim having a plurality of tracks forming a single path.

FIG. 9 is an illustration of another embodiment of a stationary rim having a plurality of tracks forming a single path.

FIG. 10 is a block diagram of an embodiment of a computer system.

### DETAILED DESCRIPTION OF ILLUSTRATIVE EMBODIMENTS

Most roulette mechanisms have a stationary rim and base and a rotating roulette wheel positioned in the middle of the base. The roulette wheel includes a number of pockets configured to hold the roulette ball. A number between 0 and 36 (and also 00 on some roulette wheels) and a color (typically green for 0 and 00 and alternating between red and black for the other numbers) are assigned to each of the pockets. The stationary rim includes a single angled annular track in which a single roulette ball manually spins. At the beginning of a game cycle, typically after further bets are closed, a dealer will either manually spin the roulette ball in the track or the roulette balls will be launched from a launch tube. The roulette ball spins in the opposite direction of the rotating roulette wheel. When the roulette ball eventually exits the track, the ball will ultimately land in one of the pockets indicating the end of that game cycle.

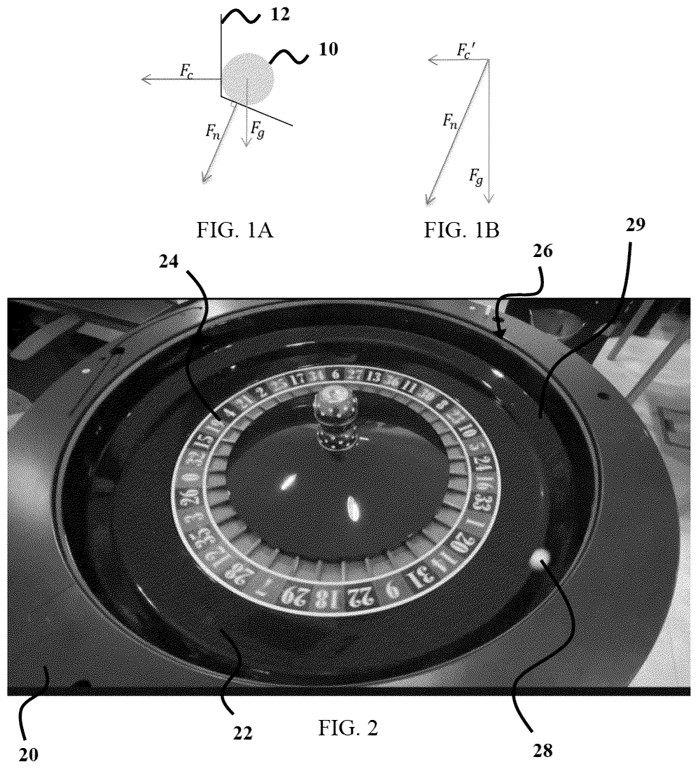

FIG. 1A is an illustration of the key forces acting on a roulette ball 10 within a track 12 of a stationary rim (not shown) of a roulette mechanism (not shown). The centrifugal force F_{c} always points directly outwards from the center of rotation of the roulette ball 10 and decreases in magnitude as the velocity of the ball decreases due to friction along the track 12. The gravity force F_{g} always points directly downward and is unchanged throughout rotation of the roulette ball 10. The normal force Fₙ is perpendicular to the surface of the track 12 on which the roulette ball 10 rotates. A deconstruction of the forces, particularly the normal force Fₙ. without the roulette ball 10 and track 12 is shown in FIG. 1B. The roulette ball 10 will circulate along the edge of the stationary rim for as long as the centrifugal force F_{c} exceeds the magnitude of the horizontal component of the normal force F_{c}′, as shown in FIG. 1B.

In a traditional roulette mechanism, during the rotation phase when the roulette ball is circulating around the track, the following parameters may apply:
Initial rotation time (when the roulette ball leaves the launch tube): t₀ (e.g., t₀=0.6 s)
   Initial rotation velocity:

$${v}_{0} ( e . g . , {v}_{0} = \frac{1 rot}{0.6 s} = 1.67 \frac{rot}{s} )$$

Critical rotation time (when the roulette ball leaves the rim and begins to circulate slower): t_{c} (e.g., t_{c}=2.1 s)
   Critical rotation velocity:

$${v}_{0} ( e . g . , {v}_{0} = \frac{1 rot}{2.1 s} = 0.48 \frac{rot}{s} )$$

Ball mass: m (e.g., m=9.0 g)
Ball diameter: d (d=18 mm)
Wheel inclination: φ(e.g., φ=15°)
Wheel diameter: 2R (e.g., 2R=734 mm)
Average number of rotations before stopping: (e.g., 16)

Traditional methods of releasing multiple roulette balls within the same stationary rim have either released the roulette balls into the same track at the same or different times or using completely separate tracks that keep the balls from colliding into one another. The present disclosure is directed to the release of a plurality of roulette balls into the same stationary rim along the same or opposite path with an offset between each release time so that the roulette balls will circulate at different heights and therefore avoid collisions. Sensors in the stationary rim (not shown but positioned around the rim) may measure the initial rotation velocity of each roulette ball at the time of launch. The initial rotation velocity may vary substantially from one launch to the next. Once the initial rotation velocity has been determined the offset before the launch of the next roulette ball may be determined, as further discussed below, in order to insure there will be no collision between the roulette balls.

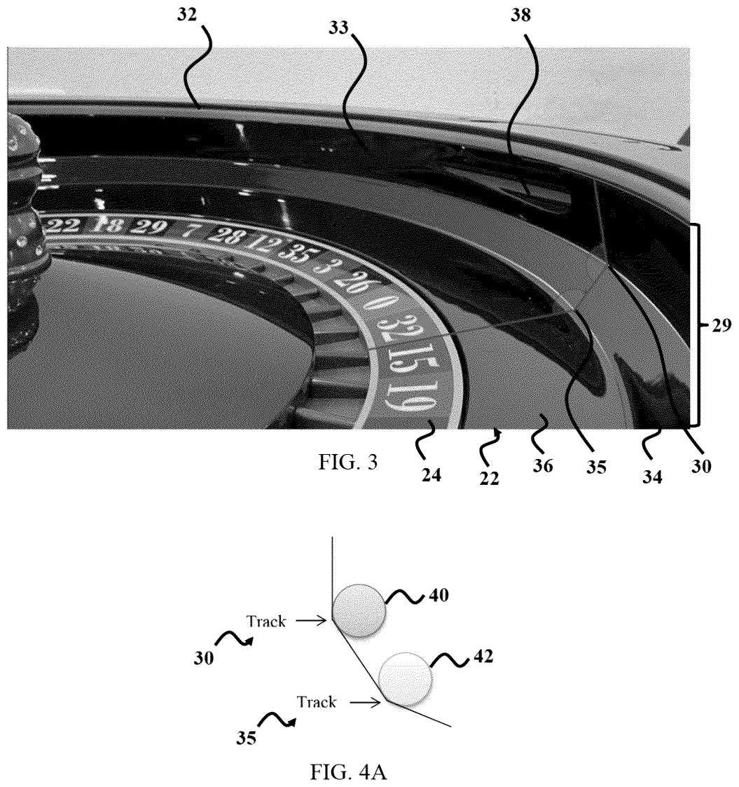

FIG. 2 illustrates a roulette mechanism 20 with a stationary rim 22 and a roulette wheel centrally positioned within the upper area 26 of the roulette mechanism 20. The stationary rim may have two or more substantially flat sections or may be a single smooth surface that gets progressively steeper toward the outer edge 32 as shown in FIG. 3. As shown in FIG. 3, a roulette ball 28 is circulating within one track of two tracks formed by the flat sections 29 of the stationary rim 22. FIG. 3 is a perspective view of a portion of the roulette mechanism of FIG. 2 illustrating more details of the stationary rim and the multiple angled annular tracks encircling the spinning roulette wheel. A more detailed view of the stationary rim 22 and the flat sections 29 is shown in FIG. 3. The flat sections 29 are highlighted with lines indicating the angle of each flat section and designating each resulting track. An upper first annular track 30 or first track 30, closest to the outer edge 32, is defined by the intersection between upper section 33 and middle section 34. A lower second annular track 35 or second track 35 is defined by the intersection between middle section 34 and lower section 36.

The exit or launch point 38 of the ball launch tube is shown in FIG. 3. While only a single launch point is illustrated, there may be two different launch points, one that causes roulette balls to be launched in a direction opposite the direction in which the roulette wheel is spinning and another that causes roulette balls to be launched in the same direction the roulette wheel is spinning. The launch points may be located adjacently, at opposite sides of the stationary rim, or elsewhere. Launching multiple different roulette balls in different directions may create a cross spiraling effect (spiraling is further discussed herein) and add interest and enjoyment to the game.

In an embodiment, a first roulette ball may be ejected from the exit 38 of the launch tube so as to land on the first track 30. The steep angle of the slope between the upper section 33 and middle section 34 may ensure that after losing a sufficient amount of speed, the first ball will leave the first track and cross over to the second track 35. A second roulette ball may be ejected from the exit 38 to follow the same trajectory as the first roulette ball, with the second roulette ball only leaving the first track once the first roulette ball has moved to either the lower section 36 or onto the roulette wheel 24. The angles of the intersections between the upper section 33 and middle section 34 and the middle section 34 and the lower section 36 may be calculated so that the two roulette balls never land on the same track at the same time, thereby ensuring a smooth and uninterrupted circulation around the stationary rim 22. The initial rotation time or launch speed of the first roulette ball may be randomly generated as is known in the art in order to insure a fair game. The launch speed of the second roulette ball may be determined based on the measured speed of the first roulette ball.

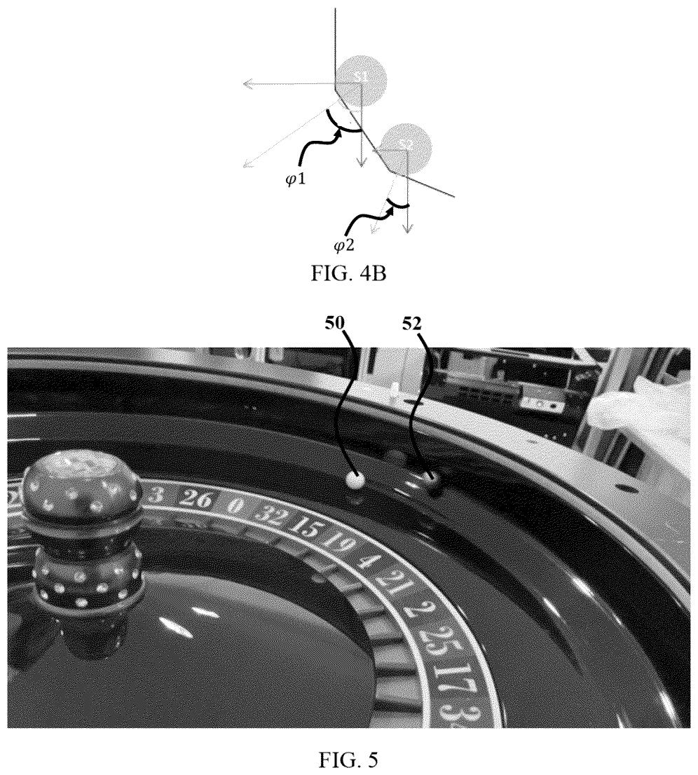

FIG. 4A is an illustration of the position of the first roulette ball 40 in the upper first track 30 and the position of the second roulette ball 42 in the lower second track 35. FIG. 4B. is an illustration of the key forces acting on the first roulette ball 40 and the second roulette ball 42 of FIG. 4A and the wheel inclination φ1 and φ2, respectively. corresponding to each ball. Based on the fixed parameters described above, and assuming the final wheel inclination is equal to the current wheel inclination, the rotation phase may be divided into two rotation stages S1 and S2 as follows:

S1:
Rotation radius: R₁ (e.g., R₁=367 mm)
Wheel inclination: φ₁ (e.g., φ₁=45°)

S2:
Rotation radius: R₂ (e.g., R₂=349 mm)
Wheel inclination: φ₂ (e.g., φ₂=15°)

The centrifugal force F_{c} may be calculated using the equation:

$${F}_{c} = \frac{m {v}^{2}}{r}$$

where m is the mass of the ball, v is the current rotation velocity and r is the rotation radius. The magnitude of the horizontal normal component F_{c}′ depends only on the inclination angle of the wheel surface. It can be calculated as follows:

F_{c}′=F_{g}*tan φ

In order to determine the critical point when a roulette ball exits one track to a track below or exits the lowest track and moves towards the roulette wheel, the centrifugal force and the horizontal normal component must be equal, resulting in the following calculation:

$${F}_{c} = {F}_{c}^{′}$$

$$\frac{m {v}^{2}}{r} = {F}_{g} * tan φ$$

$${v}^{2} = r * g * tan φ$$

where

$$g = 9.81 \frac{m}{{s}^{2}}$$

is the gravitational constant.

Key points in the rotation stage may be as follows:
Roulette ball exits the launch tube (t=0)

$$v = {v}_{0} = 2.5 \frac{rot}{s}$$

Roulette ball leaves S1

F_{c}=F_{c}′

v²=R₁*g*tan φ₁
Roulette ball leaves S2

F_{c}=F_{c}′

v²=R₂*g*tan φ₂

In order to guarantee that the roulette balls will not collide, the first roulette ball must be at least a ball-height lower than it was when it exited the launch tube by the time the second roulette ball is released.

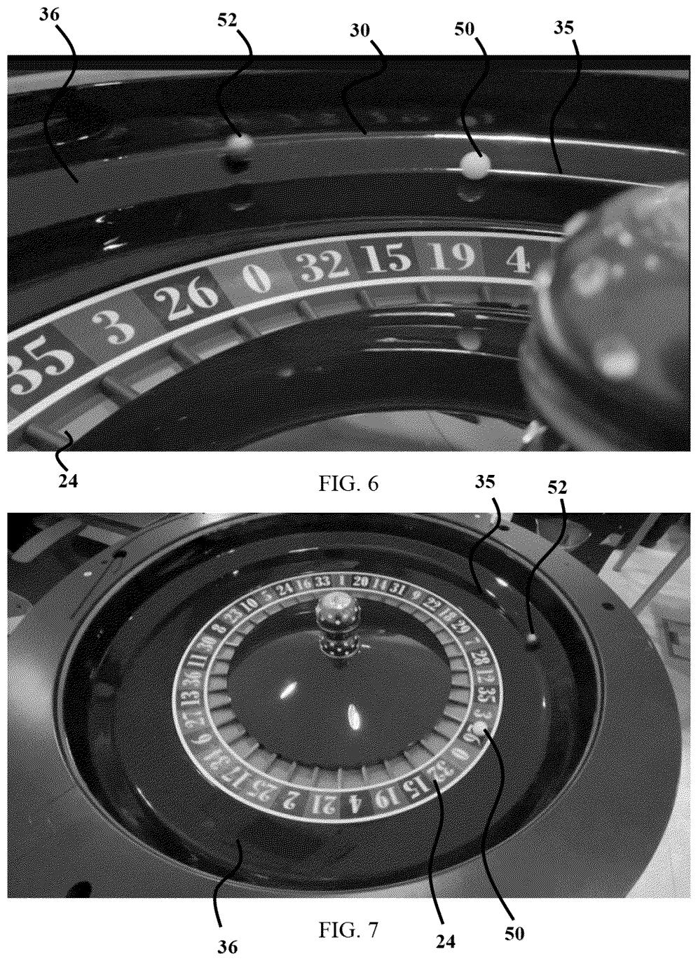

FIG. 5 is a perspective view of a portion of the roulette mechanism of FIG. 2 illustrating two roulette balls in different tracks, that is a first roulette ball 50 at rotation stage S1 and a second roulette ball 52 at rotation stage S2. FIG. 6 provides a perspective view the same two roulette balls in different portions of the tracks. The first roulette ball 50 is just beginning to move from rotation stage S1 to rotation stage S2, that is it is leaving the upper first track 30 and moving toward the lower second track 35, while the second roulette ball 50 is exiting rotation stage S2 and moving toward the lower section 36 and the roulette wheel 24, as the upper ball leaves its track and moves toward a lower track. FIG. 7 provides a perspective view of the same two roulette balls with first roulette ball 50 completely off the stationary rim and now on the spinning roulette wheel 24 and second roulette ball 52 in rotation stage S1 of the lower second track 35 and possibly preparing to move to the lower section 36.

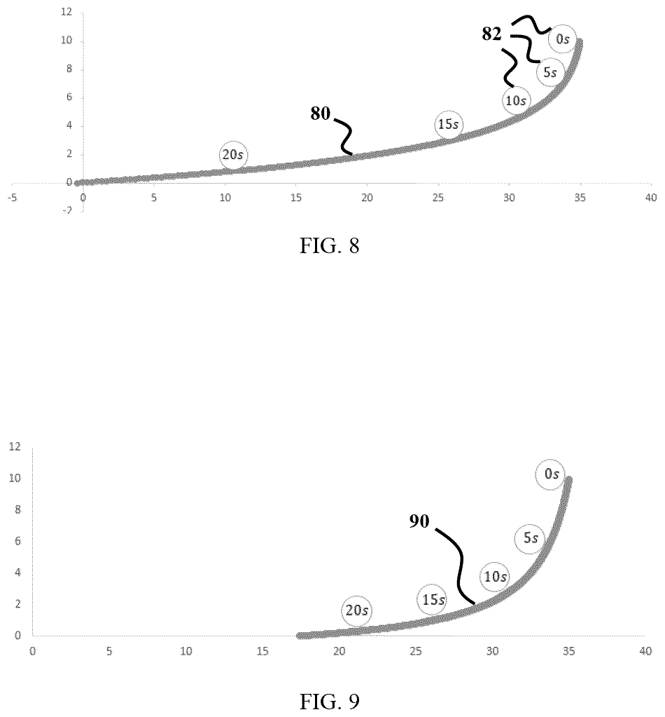

While the above embodiments may rely upon inclinations between the flat sections of the stationary rim, the stationary rim does not require intersections between flat sections to define physically distinct tracks that roulette balls may follow during a game cycle. FIG. 8 provides an illustration of an embodiment of a stationary rim 80 having a plurality of tracks, each defined by a rotation stage determined by each roulette ball's angular rotation. Angular rotation of a roulette ball may be defined as follows:
Angular velocity:

ω=ω₀*e^{-t/τ}
Path travelled:

$$Δθ = ω * Δ t$$

$$ϑ = {\int }_{0}^{{t}_{1}} ω dt = {ω}_{0} τ ( 1 - {e}^{{-}^{{t}_{1 {/}_{τ}}}} )$$

In order to guarantee that the roulette balls do not vertically collide it may be necessary to ensure that the height of a first roulette ball on the stationary rim is at least a roulette ball diameter lower than the initial height of a second roulette ball on the stationary rim at the time the second roulette ball is launched. In the case of a flatter stationary rim, the necessary separation may be more horizontal. These conditions may need to hold throughout the game cycle and can be verified based on sensor measurements of the separation and roulette ball velocity throughout the game cycle, with both roulette balls moving toward the roulette wheel at substantially the same rate. This separation assumes that the height of a roulette ball on the stationary rim is directly proportional to the rotation time. That is: h∝t, where h is stationary rim height and t is rotation time.

If the following values are taken as initial conditions for the design of an appropriate working stationary rim of a roulette mechanism:
Initial rotation radius: R (e.g., R=0.35 m)
Initial rotation velocity: ω₀ (e.g., ω₀=12 s⁻¹) Rotational velocity constant: τ (e.g., τ=10 s⁻¹),
the shape of the continuously curved stationary rim 80 may appear as shown in FIG. 8. The different numbered roulette balls 82 represent each ball between a launch time of 0 s (seconds), 5 s, 10 s, 15 s, and 20 s. At 0 s the roulette ball makes approximately 2 laps around the stationary rim 80 per second, dropping to approximately 1.2 laps per second at 5 s, approximately 0.8 laps per second at 10 s, and significantly slowing to about 0.3 lap per second by 20 s. However, as can be seen in FIG. 8, as a result of attempting to maintain the height difference between the roulette balls, the curve of the lower portion of the stationary rim 80 levels out significantly, thereby requiring a much larger, by radius, stationary rim than in more traditional roulette mechanisms.

FIG. 9 is an illustration of another embodiment of a stationary rim 90 having a plurality of tracks where a constant distance between the centers of rotation of roulette balls following different tracks of a path is maintained. In this case the height of a roulette ball on the stationary rim 90 is directly proportional to the rotation velocity. That is: h∝ϑ, where h is stationary rim height and ϑ is rotation velocity. As depicted in FIG. 9, this embodiment enables the stationary rim 90 to have a smally radius yet maintain a sufficient separation between the roulette balls at 0 s, 5 s, 10 s, 15 s, and 20 s.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

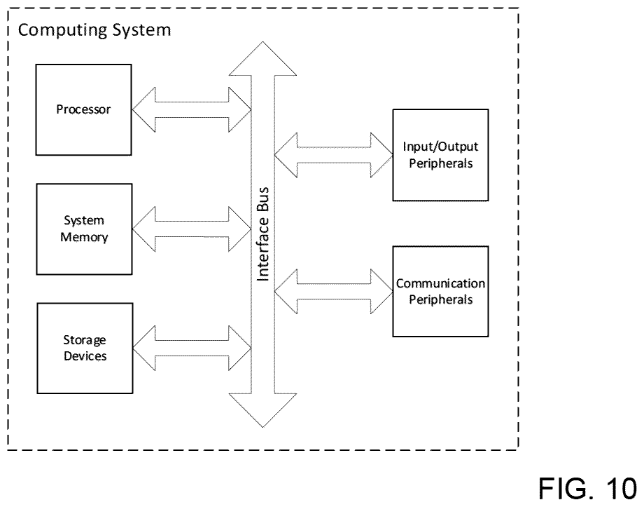

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 10 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a multi-ball roulette mechanism comprises a base; an annular stationary rim mounted on the base, the stationary rim having a central opening and an upwardly curved face around which two or more roulette balls travel; a rotating roulette wheel positioned in the central opening of the stationary rim and supported by the base, the roulette wheel including a number of pockets configured to hold one or more roulette balls among the two or more roulette balls traveling from the curved face onto the roulette wheel, each of the pockets being identified by a number and a color and being configured to spin in a first direction; and a roulette ball launching system configured to launch the two or more roulette balls spinning around the stationary rim in a second direction. The curved face of the stationary rim includes one or more paths around which at least a first roulette ball and a one or more additional roulette balls among the two or more roulette balls travel. The first roulette ball is launched by the roulette ball launching system onto the one or more paths to rotate around the stationary rim while moving down the curved face toward the roulette wheel as the first roulette ball loses momentum. The one or more additional roulette balls are launched by the roulette ball launching system onto the one or more paths without colliding with the first roulette ball or any additional roulette balls while travelling on the one or more paths.

In the embodiment, wherein a time difference between a roulette ball and a subsequent roulette ball among the two or more roulette balls are launched is sufficient to prevent the roulette ball and the subsequent roulette ball from colliding.

In the embodiment, wherein a time difference between a roulette ball and a subsequent roulette ball among the two or more roulette balls are launched and an initial rotational velocity of the roulette ball and the subsequent roulette ball are sufficient to prevent any of the roulette balls on the curved face from colliding.

In the embodiment, wherein the curved face includes an upper track and a lower track and a plurality of sections, wherein the upper track is formed between a first section and a second section and the lower track is formed between the second section and a third section.

In the embodiment, wherein the first section, the second section and the third section are substantially flat.

In the embodiment, wherein the first roulette ball moves to the lower track prior to the one or more additional roulette balls being launched onto the upper track, and wherein the first roulette ball moves out of the lower track prior to the one or more additional roulette balls moving to the lower track.

In the embodiment, wherein the curved face is smooth and curves at continuously sharper angles toward an outer edge of the stationary rim, and wherein the two or more roulette balls spiral down the curved face toward the roulette wheel.

In the embodiment, wherein a roulette ball and a subsequent roulette ball among the two or more roulette balls have a diameter, and wherein the roulette ball and the subsequent roulette ball move down the curved face at a rate sufficient to maintain at least the diameter as a distance on the curved face between the roulette ball and the subsequent roulette ball.

In the embodiment, wherein a roulette ball and a subsequent roulette ball among the two or more roulette balls move down the curved face at a rate sufficient to maintain a predetermined minimum distance between roulette ball and the subsequent roulette ball.

In the embodiment, wherein the roulette ball launching system includes multiple launchers, and wherein the second direction is equal to the first direction, opposite of the first direction, or both.

In the embodiment, wherein a ball speed of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball speed of the first roulette ball and the subsequent roulette balls and so that at least a predetermined minimum distance between the two or more roulette balls is maintained.

In the embodiment, wherein a ball position of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball position of the first roulette ball and the subsequent roulette balls and so that at least a predetermined minimum distance between the two or more roulette balls is maintained.

In an embodiment, a multi-ball roulette mechanism comprises a base; an annular stationary rim mounted on the base, the stationary rim having a central opening and an upwardly curved face around which two or more roulette balls travel; a rotating roulette wheel positioned in the central opening of the stationary rim and supported by the base, the roulette wheel including a number of pockets configured to hold one or more roulette balls among the two or more roulette balls traveling from the curved face onto the roulette wheel, each of the pockets being identified by a number and a color and being configured to spin in a first direction; and a roulette ball launching system configured to launch the two or more roulette balls spinning around the stationary rim in a second direction. The curved face of the stationary rim includes at least an upper track and a lower track around which a first roulette ball and one or more additional roulette balls among the two or more roulette balls travel. The first roulette ball is launched by the roulette ball launching system onto the upper track to rotate around the stationary rim while moving down the curved face toward the lower track and the roulette wheel as the first roulette ball loses momentum. The one or more additional roulette balls are launched by the roulette ball launching system onto the upper track path after at least the first roulette ball moves toward the lower track and without colliding with the first roulette ball or any additional roulette balls while travelling on the upper track or the lower track.

In the embodiment, wherein a time difference between when a roulette ball and a subsequent roulette ball among the two or more roulette balls are launched is sufficient to prevent the roulette ball and the subsequent roulette ball from colliding.

In the embodiment, wherein a time difference between when a roulette ball and a subsequent roulette ball among the two or more roulette balls are launched and an initial rotational velocity of the roulette ball and the subsequent roulette ball are sufficient to prevent any of the roulette balls on the curved face from colliding.

In the embodiment, wherein the upper track is formed between a first section and a second section and the lower track is formed between the second section and a third section.

In the embodiment, wherein the first section, the second section and the third section are substantially flat.

In the embodiment, wherein the first roulette ball moves out of a track prior to at least a second roulette ball moving to the track.

In the embodiment, wherein the curved face is smooth and curves at continuously sharper angles toward an outer edge of the stationary rim.

In the embodiment, wherein the upper track and the lower track are part of one or more paths that spiral down the curved face from a launch point to the roulette wheel.

In the embodiment, wherein a roulette ball and a subsequent roulette ball among the two or more roulette balls have a diameter, and wherein the roulette ball and the subsequent roulette balls move down the curved face at a rate sufficient to maintain at least the diameter as a distance on the curved face between the roulette ball and the subsequent roulette ball.

In the embodiment, wherein a roulette ball and a subsequent roulette ball among the two or more roulette balls move down the curved face at a rate sufficient to maintain a predetermined minimum distance between the roulette ball and the subsequent roulette ball.

In the embodiment, wherein the roulette ball launching system includes multiple launchers, and wherein the second direction is equal to the first direction, opposite of the first direction, or both.

In the embodiment, wherein a ball speed of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball speed of the first roulette ball and the subsequent roulette balls and so that at least a predetermined minimum distance between the two or more roulette balls is maintained.

In the embodiment, wherein a ball position of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball position of the first roulette ball and the subsequent roulette balls and so that at least a predetermined minimum distance between the two or more roulette balls is maintained.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A multi-ball roulette mechanism, comprising:
a base;
an annular stationary rim mounted on the base, the stationary rim having a central opening and an upwardly curved face around which two or more roulette balls travel;
a rotating roulette wheel positioned in the central opening of the stationary rim and supported by the base, the roulette wheel including a number of pockets configured to hold one or more roulette balls among the two or more roulette balls traveling from the curved face onto the roulette wheel, each of the pockets being identified by a number and a color and being configured to spin in a first direction; and
a roulette ball launching system configured to launch the two or more roulette balls spinning around the stationary rim in a second direction;
wherein the curved face of the stationary rim includes one or more paths around which at least a first roulette ball and one or more additional roulette balls among the two or more roulette balls travel,
wherein the first roulette ball is launched by the roulette ball launching system onto one of the one or more paths to rotate around the stationary rim while moving down the curved face toward the roulette wheel as the first roulette ball loses momentum, and
wherein the one or more additional roulette balls are launched by the roulette ball launching system onto the one or more paths without colliding with the first roulette ball or any additional roulette balls while travelling on the one or more paths.

2. The multi-ball roulette mechanism of claim 1, wherein a time difference between a roulette ball and a subsequent roulette ball among the two or more roulette balls are launched is sufficient to prevent the roulette ball and the subsequent roulette ball from colliding.

3. The multi-ball roulette mechanism of claim 1, wherein a time difference between a roulette ball and a subsequent roulette ball among the two or more roulette balls are launched and an initial rotational velocity of the roulette ball and the subsequent roulette ball are sufficient to prevent any of the roulette balls on the curved face from colliding.

4. The multi-ball roulette mechanism of claim 1, wherein the curved face includes an upper track and a lower track and a plurality of sections, wherein the upper track is formed between a first section and a second section and the lower track is formed between the second section and a third section.

5. The multi-ball roulette mechanism of claim 4, wherein the first section, the second section and the third section are substantially flat.

6. The multi-ball roulette mechanism of claim 4, wherein the first roulette ball moves to the lower track prior to the one or more additional roulette balls being launched onto the upper track, and wherein the first roulette ball moves out of the lower track prior to the one or more additional roulette balls moving to the lower track.

7. The multi-ball roulette mechanism of claim 1, wherein the curved face is smooth and continuously curves at sharper angles toward an outer edge of the stationary rim, and wherein the two or more roulette balls spiral down the curved face toward the roulette wheel.

8. The multi-ball roulette mechanism of claim 7, wherein a roulette ball and a subsequent roulette ball among the two or more roulette balls have a diameter, and wherein the roulette ball and the subsequent roulette ball move down the curved face at a rate sufficient to maintain at least the diameter as a distance on the curved face between the roulette ball and the subsequent roulette ball.

9. The multi-ball roulette mechanism of claim 7, wherein a roulette ball and a subsequent roulette ball among the two or more roulette balls move down the curved face at a rate sufficient to maintain a predetermined minimum distance between roulette ball and the subsequent roulette ball.

10. The multi-ball roulette mechanism of claim 1, wherein the roulette ball launching system includes multiple launchers, and wherein the second direction is equal to the first direction, opposite of the first direction, or both.

11. The multi-ball roulette mechanism of claim 1, wherein a ball speed of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball speed of the first roulette ball and the subsequent roulette balls and so that at least a predetermined minimum distance between the two or more roulette balls is maintained.

12. The multi-ball roulette mechanism of claim 1, wherein a ball position of the two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball position of the first roulette ball and the subsequent roulette balls and so that at least a predetermined minimum distance between the two or more roulette balls is maintained.

13. A multi-ball roulette mechanism, comprising:
a base;
an annular stationary rim mounted on the base, the stationary rim having a central opening and an upwardly curved face around which two or more roulette balls travel;
a rotating roulette wheel positioned in the central opening of the stationary rim and supported by the base, the roulette wheel including a number of pockets configured to hold one or more roulette balls among the two or more roulette balls traveling from the curved face onto the roulette wheel, each of the pockets being identified by a number and a color and being configured to spin in a first direction; and
a roulette ball launching system configured to launch the two or more roulette balls spinning around the stationary rim in a second direction;
wherein the curved face of the stationary rim includes at least an upper track and a lower track around which a first roulette ball and one or more additional roulette balls among the two or more roulette balls travel,
wherein the first roulette ball is launched by the roulette ball launching system onto the upper track to rotate around the stationary rim while moving down the curved face toward the lower track and the roulette wheel as the first roulette ball loses momentum, and
wherein the one or more additional roulette balls are launched by the roulette ball launching system onto the upper track path after at least the first roulette ball moves toward the lower track and without colliding with the first roulette ball or any additional roulette balls while travelling on the upper track or the lower track.

14. The multi-ball roulette mechanism of claim 13, wherein a time difference between when a roulette ball and a subsequent roulette ball among the two or more roulette balls are launched is sufficient to prevent the roulette ball and the subsequent roulette ball from colliding.

15. The multi-ball roulette mechanism of claim 13, wherein a time difference between when a roulette ball and a subsequent roulette ball among the two or more roulette balls are launched and an initial rotational velocity of the roulette ball and the subsequent roulette ball are sufficient to prevent any of the roulette balls on the curved face from colliding.

16. The multi-ball roulette mechanism of claim 13, wherein the upper track is formed between a first section and a second section and the lower track is formed between the second section and a third section.

17. The multi-ball roulette mechanism of claim 16, wherein the first section, the second section and the third section are substantially flat.

18. The multi-ball roulette mechanism of claim 13, wherein the first roulette ball moves out of a track prior to at least a second roulette ball moving to the track.

19. The multi-ball roulette mechanism of claim 13, wherein the curved face is smooth and continuously curves at sharper angles toward an outer edge of the stationary rim.

20. The multi-ball roulette mechanism of claim 19, wherein the upper track and the lower track are part of one or more paths that spiral down the curved face from a launch point to the roulette wheel.

21. The multi-ball roulette mechanism of claim 13, wherein a roulette ball and a subsequent roulette ball among the two or more roulette balls have a diameter, and wherein the roulette ball and the subsequent roulette balls move down the curved face at a rate sufficient to maintain at least the diameter as a distance on the curved face between the roulette ball and the subsequent roulette ball.

22. The multi-ball roulette mechanism of claim 13, wherein a roulette ball and a subsequent roulette ball among the two or more roulette balls move down the curved face at a rate sufficient to maintain a predetermined minimum distance between the roulette ball and the subsequent roulette ball.

23. The multi-ball roulette mechanism of claim 13, wherein a ball speed of two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball speed of the first roulette ball and the subsequent roulette balls and so that at least a predetermined minimum distance between the two or more roulette balls is maintained.

24. The multi-ball roulette mechanism of claim 13, wherein a ball position of two or more roulette balls travelling on the stationary rim is measured one or more times per revolution, and wherein an initial speed of roulette balls subsequent to the first roulette ball and a time difference between when the first roulette ball is launched and each of the subsequent roulette balls are launched is based on the measurements of the ball position of the first roulette ball and the subsequent roulette balls and so that at least a predetermined minimum distance between the two or more roulette balls is maintained.

25. The multi-ball roulette mechanism of claim 13, wherein the roulette ball launching system includes multiple launchers, and wherein the second direction is equal to the first direction, opposite of the first direction, or both.
